(19) United States
(12) Patent Application Publication
(10) Pub. No.: US 2015/0203625 A1
(43) Pub. Date: Jul. 23, 2015

(54) HARDENERS FOR COLD CURING EPOXY SYSTEMS

(71) Applicant: DOW GLOBAL TECHNOLOGIES LLC, Midland, MI (US)

(72) Inventors: Markus Schroetz, Ochsenhausen (DE); Marcus Pfarherr, Mittelbiberach (DE); Jeurgen Gaebel, Laupheim (DE)

(73) Assignee: DOW GLOBAL TECHNOLOGIES LLC, Midland, MI (US)

(21) Appl. No.: 14/383,912

(22) PCT Filed: Mar. 18, 2013
(86) PCT No.: PCT/US13/32765

§ 371 Date: Sep. 9, 2014

Related U.S. Application Data
(60) Provisional application No. 61/621,631, filed on Apr. 9, 2012.

(51) Int. Cl. C08G 59/14; C09D 163/00; C09D 163/04; C09D 5/00

(52) U.S. Cl. CPC C08G 59/1477; C08G 59/145; C09D 5/002; C09D 163/00; C09D 163/04

(57) ABSTRACT

A hardener composition comprising: a) a non-isolated adduct of i) a monofunctional epoxy; and ii) a first amine; b) a second amine; c) a modifier; and d) an accelerator, is disclosed. The hardener composition can be combined with an epoxy resin to make a composition useful to prepare primers.

### REFERENCE TO RELATED APPLICATIONS

The present application claims the benefit of U.S. Provisional Application No. 61/621,631, filed on Apr. 9, 2012.

### BACKGROUND OF THE INVENTION

1. Field of the Invention

The present invention is related to cold curing epoxy systems. Specifically, the present invention is related to hardeners for cold curing epoxy systems.

2. Introduction

Cold curing epoxy systems are suitable for a wide range of industrial applications, such as floorings, mortars, adhesives, coatings, lacquers, and paints. Most of the cold curing amine hardeners contain benzyl alcohol as a modifier, which is a volatile organic compound (VOC) and causes emissions, even after curing the epoxy system.

Non-VOC systems either have unfavorably high viscosities, bad surface appearances, or slow curing times. These can be overcome by adding alkyl phenols, such as nonyl phenol or p-t-butylphenol or bisphenol A into the hardener. However, these substances are unfavorable due to being classified by the European Union as R 62 substances, bearing a risk of impaired fertility.

Another approach is the addition of free amines. However, too much free amine in a hardener can lead to whitening or blushing during curing. A solution to this is to use isolated adducts in hardeners. This can lead to good hardener properties overall, however, the isolation of an adduct requires the removal of any unreacted amine by means of distillation under a vacuum, which is time and energy intensive.

Therefore, a need remains for an amine hardener without volatile organic compounds, comprised of favorable substances, and which has a workable viscosity.

### SUMMARY OF THE INVENTION

In an embodiment of the invention, there is disclosed a hardener composition comprising, consisting of or consisting essentially of: a) a non-isolated adduct of i) a monofunctional epoxy; and

ii) a first amine; b) a second amine; c) a modifier; and d) an accelerator.

### DETAILED DESCRIPTION OF THE INVENTION

In an embodiment of the invention, there is disclosed a hardener composition comprising, consisting of or consisting essentially of: a) a non-isolated adduct of i) a monofunctional epoxy; and

ii) a first amine; b) a second amine; c) a modifier; and d) an accelerator.
Component (a)—Monofunctaional Epoxy and First Amine

In an embodiment, one component of the composition is a non-isolated adduct of a monofunctional epoxy i) and a first amine ii).

Examples of monofunctional epoxies i) include but are not limited to phenyl glycidyl ether, cresyl glycidyl ether, p.-t. butyl phenyl glycidyl ether, C12/C14 alkyl glycidyl ether, phenylglycidyl ether, and 2-ethylhexyl glycidyl ether, branched glycidyl ethers such as C13/15 alcohol glycidyl ethers and glycidyl esters such as Versatic Acid glycidyl ester. Examples of the first amine ii) include but are not limited to aliphatic polyamines, arylaliphatic polyamines, cycloaliphatic polyamines, aromatic polyamines, heterocyclic polyamines, polyalkoxypolyamines, and combinations thereof. The alkoxy group of the polyalkoxypolyamines is an oxyethylene, oxypropylene, oxy-1,2-butylene, oxy-1,4-butylene or a co-polymer thereof.

Examples of aliphatic polyamines include, but are not limited to ethylenediamine (EDA), diethylenetriamine (DETA), triethylenetetramine (TETA), trimethyl hexane diamine (TMDA), hexamethylenediamine (HMDA), N-(2-aminoethyl)-1,3-propanediamine (N3-Amine), N,N′-1,2-ethanediylbis-1,3-propanediamine (N4-amine), and dipropylenetriamine. Examples of arylaliphatic polyamines include, but are not limited to m-xylylenediamine (mXDA), and p-xylylenediamine Examples of cycloaliphatic polyamines include, but are not limited to 1,3-bisaminocyclohexylamine (1,3-BAC), isophorone diamine (IPDA), and 4,4′-methylenebiscyclohexanamine. Examples of aromatic polyamines include, but are not limited to m-phenylenediamine, diaminodiphenylmethane (DDM), and diaminodiphenylsulfone (DDS). Examples of heterocyclic polyamines include, but are not limited to N-aminoethylpiperazine (NAEP), and 3,9-bis(3-aminopropyl) 2,4,8,10-tetraoxaspiro(5,5)undecane. Examples of polyalkoxypolyamines where the alkoxy group is an oxyethylene, oxypropylene, oxy-1,2-butylene, oxy-1,4-butylene or a co-polymer thereof include, but are not limited to 4,7-dioxadecane-1,10-diamine, 1-propanamine,2,1-ethanediyloxy))bis(diaminopropylated diethylene glycol) (ANCAMINE® 1922A); poly(oxy(methyl-1,2-ethanediyl)), alpha-(2-aminomethylethyl)omega-(2-aminomethylethoxy) (JEFFAMINE® D-230, D-400); triethyleneglycoldiamine and oligomers (JEFFAMINE® XTJ-504, JEFFAMINE® XTJ-512), poly(oxy(methyl-1,2-ethanediyl)),alpha,alpha′-(oxydi-2,1-ethanediyl)bis(omega-(aminomethylethoxy)) (JEFFAMINE® XTJ-511); bis(3-aminopropyl)polytetrahydrofuran 350; bis(3-aminopropyl)polytetrahydrofuran 750; poly(oxy(methyl-1,2-ethanediyl)), a-hydro-w-(2-aminomethylethoxy) ether with 2-ethyl-2-(hydroxymethyl)-1,3-propanediol (JEFFAMINE® T-403), and diaminopropyl dipropylene glycol.

In an embodiment, monofunctional epoxy component i) is generally used in molar excess compared to the first amine component ii) or up to a maximum ratio of 1:1, to ensure that component a) is an aminofunctional molecule with an unreacted amine.

Generally, one of ordinary skill in the art can determine the amount of non-isolated adduct a) to use in the hardener formulation. The nature of the first amine component ii) used and the degree of the reaction with monofunctional epoxy component i) can strongly affects the viscosity of the adduct a). If adduct a) is highly viscous, then less can be used in the hardener formulation. If adduct a) has a lower viscosity, then more of the adduct can be used in the overall formulation.

In an embodiment, the non-isolated adduct is present in the composition in the range of from 10 weight percent to 80 weight percent, based on the total weight of the composition. The adduct is present in the composition in the range of from 15 weight percent to 70 weight percent in another embodiment, and from 20 weight percent to 60 weight percent in yet another embodiment.

Component (b)—Second Amine

In an embodiment, the composition can contain a second amine. The second amine can be any of the amines listed above. In an embodiment, the second amine can be poly(oxy(methyl-1,2-ethanediyl)), or alpha-(2-aminomethylethyl)omega-(2-aminomethylethoxy) (JEFFAMINE® D-230 or JEFFAMINE® D-400).

The second amine is generally present in an amount in the range of 10 weight percent to 80 weight percent, based on the total weight of the composition. In an embodiment, the second amine can be present in a range of from 15 weight percent to 70 weight percent, based on the total weight of the composition, and from 20 weight percent to 60 weight percent, based on the total weight of the composition in yet another embodiment.

Component (c)—Modifier

The composition also includes a modifier. The modifier is useful for dilution and may accelerate the curing speed in combination with epoxy resins. The modifier can also enhance surface appearance.

Examples of modifiers include, but are not limited to styrenated phenol, diisopropylnaphthalene, polyalkylene glycols, ethers of polyalkylene glycols, benzyl alcohol, and high boiling mono- or polyhydric alcohols.

The modifier is generally present in a range of from 5 weight percent to 50 weight percent, based on the total weight of the composition.

Component (d)—Aaccelerator

The composition can also include an accelerator, which accelerates the curing speed of the composition with an epoxy resin.

Examples of accelerators include, but are not limited to salicylic acid, calcium nitrate, bisphenol A, bisphenol F, resorcinol, and hydroquinone or other carboxylic and/or phenolic group containing component.

The accelerator is generally present in the composition in the range of from 0.5 weight percent to 15 weight percent, based on the total weight of the composition.

### Optional Components

Third Amine

In an embodiment, the composition can contain a third amine. Amines that can be used include, but are not limited to amines with high reactivity, such as for example 1,3-bisaminocyclohexylamine (1,3-BAC) or N-aminoethylpiperazine (NAEP), diethylenetriamine (DETA), triethylenetetramine (TETA), m-xylylenediamine (mXDA) and 2-methyl-1,5-pentanediamine (MPMD).

The third amine is generally present in the composition in a range of from 5 weight percent to 50 weight percent, based on the total weight of the composition. The third amine is present in the composition in the range of from 5 weight percent to 25 weight percent in another embodiment, and in the range of from 5 weight percent to 10 weight percent, in yet another embodiment, based on the total weight of the composition.

In an embodiment, adducts of liquid epoxy resins (such as for example, DER™ 330, DER™ 331, and DER™ 354) with one of the above-mentioned amines can be used.

### Process for Producing the Composition

In an embodiment, the formation of component a), the non-isolated adduct, takes place at elevated temperatures from 60 to 120° C. under reaction control by speed of addition. The addition speed depends mainly on the cooling power of the reactor used. In an embodiment, the temperature is in the range of from 75° C. to 85° C. The reactor is charged with the first amine and the monofunctional epoxy is added from top under stirring. After addition is finished, a post reaction of 20 to 40 minutes is performed. During the post reaction time the reaction between the monofunctional epoxy and amine continues to completion, so that no unreacted epoxy remains in the reaction mixture.

The adduct is a non-isolated adduct. Once the reaction is completed, the adduct a) does not undergo an extra distillation step to remove any remaining unreacted amine component.

Once adduct a) is formed, the other components can be added in any combination or sub-combination.

### Curable Composition Product

In an embodiment, a curable composition comprises, consists of, of consists essentially of: I) the above-described hardener and II) an epoxy resin.

In an embodiment, the epoxy resin is a liquid epoxy resin. Examples of liquid epoxy resins that can be used include, but are not limited to bisphenol-A diglycidyl ethers (BADGE), bisphenol-F diglycidyl ethers (BFDGE), and epoxy novolacs. In another embodiment, the epoxy resin can be a solid bisphenol A epoxy resin.

The curable composition can be optionally diluted with reactive diluents such as for example cresyl glycidyl ether (CGE), p. t.-butylphenyl glycidyl ether (ptBPGE), C12/C14 glycidyl ether, butanediol diglycidyl ether (BDDGE), hexanediol-diglycidyl ether (HDDGE), branched glycidyl ethers such as C13/15 alcohol glycidyl ether, and glycidyl esters such as Versatic Acid glycidyl esters.

In an embodiment, the hardener component and the epoxy resin are mixed according to the hardener equivalent weight (HEW) and epoxide equivalent weight (EEW) to ensure that 1 equivalent of epoxy reacts with 1 equivalent amine hydrogen. The composition is cured at ambient temperature. These compositions are generally used as primers for concrete and floorings.

### EXAMPLES

The following examples and comparative examples further illustrate the present invention in detail but are not to be construed to limit the scope thereof.

In the following Examples, various terms and designations used such as for example:

Polypox® E 270 and E 403: reactive diluted epoxy resins from UPPC

E 270: A/F type with hexanediol diglycidyl ether and butanediol diglycidyl ether diluted

E 403: A/F with C12/C14 glycidyl ether

Polypox® IH 7011: hardener from UPPC, based on isolated MPMD-Cresyl glycidyl ether adducts

### Example 1

Adducts:

IPD-Adduct I:

596.9 grams of isophorone diamine (IPDA) were heated to 90° C. Under stirring, 403.1 grams ptBPGE were added. After one hour, 1000 grams of a high viscous clear liquid was yielded.

Amine equivalent: 83 g/equiv.

Viscosity @25° C.: 27000 mPas

Amine number: 406 mg KOH/g

IPD-Adduct II:

596.9 grams of IPDA was heated to 90° C. Under stirring 307.0 grams of CGE was added. After one hour, 903.9 grams of a high viscous clear liquid was yielded.

Amine equivalent: 74 g/equiv.

Viscosity @25° C.: 4160 mPas

Amine number: 436 mg KOH/g

### Inventive Examples

Hardener I:

At 80° C., 24 grams of salicylic acid were added to 216 grams of Jeffamine® D-230 while stirring. The salicylic acid did not dissolve/neutralize spontaneously, so 30 grams of 1,3-BAC was added, yielding a clear solution. 270 grams of Adduct I was added, followed by 60 grams of Sanko SP-F (an araliphatic phenol from Sanko Corp., Japan). The mixture was homogenized at 80° C., cooled and drawn off.

Amine equivalent: 80 g/equiv.

Viscosity @25° C.: 470 mPas

Amine number: 396 mg KOH/g

Color: 1.9 Gardner

Hardener II:

At 80° C., 24 grams salicylic acid were added to 216 grams of Jeffamine™ D-230 under stirring. The salicylic acid did not dissolve/neutralize spontaneously, so 30 grams of 1,3-BAC was added, yielding a clear solution. 270 grams of Adduct II was added, followed by 60 grams of Sanko SP-F (an araliphatic phenol from Sanko Corp, Japan). The mixture was homogenized at 80° C., cooled and drawn off.

Amine equivalent: 74 g/equiv.

Viscosity @25° C.: 300 mPas

Amine number: 410 mg KOH/g

Color: 1.5 Gardner

### Comparative Example A and Comparative Example B

For Comparative Examples A and B, Polypox® IH 7011 was used as a hardener. Polypox® IH 7011 is a commercially available hardener made by UPPC. It is a hardener formulation containing an isolated adduct. Comparative Example A was made with Polypox® E 270 and Comparative Example B was made with Polypox® E 403.

Films with the hardeners were made by mixing the epoxy resin (eg. Polypox® E 403 or Polypox® E 270) with the hardener formulation. Generally, one epoxy equivalent is mixed with one amine equivalent. The amounts of the hardener and epoxy components are given in Table 1, below.

TABLE 1

| Example | Hardener (grams) | Epoxy (grams) |
|---|---|---|
| Inventive Example 1A | 47 | 100 |
| (Hardener I with Polypox ® E | | |
| 270) | | |
| Inventive Example 2A | 45 | 100 |
| (Hardener II with Polypox ® E | | |
| 270) | | |
| Comparative Example A | 48 | 100 |
| (Polypox ® IH 7011 with | | |
| Polypox ® E 270) | | |
| Inventive Example 1B | 42 | 100 |
| (Hardener I with Polypox ® E | | |
| 403) | | |
| Inventive Example 2B | 40 | 100 |
| (Hardener II with Polypox ® E | | |
| 403) | | |
| Comparative Example B | 43 | 100 |
| (Polypox ® IH 7011 with | | |
| Polypox ® E 403) | | |

After homogenization of both components for 2 minutes, the liquid mixture was poured into molds, so that the film thickness was 3 mm and was cured for 7 days at room temperature.

Testing of films was done in the following manner:

A 3 mm film was fully cured for 7 days at room temperature (about 23° C.). A cotton pad was soaked with a test liquid such as for example, gasoline, alcohol mixture (B.P.G. 5b consisting of 46 vol % each ethanol and isopropanol with 4 vol % water), acetic acid, and methylisobutylketone (MIBK). The cotton pad was placed on the film's surface and covered to prevent evaporation of the test liquid. The 1, 2 and 7 day values were taken in terms of percentile decrease of Shore D hardness. The decrease in Shore D hardness over a predetermined period of time is a good indication for the resistance against the different test liquids.

### Results

A sample of each Comparative Example A and B (with same comparative hardener but with two different resins), Examples 1A and 1B (with same inventive hardener I but with two different resins), and Examples 2A and 2B (with same inventive hardener II but with two different resins) were exposed to the solutions for 7 days (168 hours) by placing a cotton pad that is saturated with the solution on the sample and covering the pad and sample. After 1 day (24 hours) of exposure, 2 days (48 hours) of exposure, and 7 days of exposure the Shore D hardness of the samples was measured. The Shore D hardness measurements are shown in Tables 1-6.

The percent change in Shore D hardness, as shown as percent % A, was determined with the initial hardness and the final hardness after 168 hours of exposure to the solutions. The percent change in Shore D hardness was calculated as (1−(final hardness/initial hardness))*100, where a negative percent change in hardness indicated a greater value for initial hardness than final hardness.

The test liquids were a twenty weight percent sulfuric acid solution, a twenty weight percent sodium hydroxide solution, B.P.G. 5b, a five weight percent acetic acid solution, a ten weight percent acetic acid solution, gasoline, xylene, and methyl isobutyl ketone (MIBK). Specific compounds are listed below:

Acetic acid, analytical grade, available from Merck KGaA.

Sulfuric acid, analytical grade, available from Merck KGaA.

Sodium hydroxide, analytical grade, available from Merck KGaA.

Bau- and Prüfgrundsätze Gruppe 5b of the DIBT (Policy for Construction and Testing Group 5b of the German Institute for Construction Technique) (hereinafter designated as ‘B.P.G. 5b’), a mixture of 48 volume percent methanol, analytical grade, available from Merck KGaA, 48 volume percent isopropanol, analytical grade, available from Merck KGaA, and 4 volume percent water.

Gasoline, available from Esso (Exxon).

Xylene, analytical grade, available from Merck KGaA.

Methyl isobutyl ketone (MIBK), analytical grade, available from Merck KGaA.

The results are shown in Tables 2-7, below.

TABLE 2
Inventive Example 1A (Hardener I with Polypox ® E 270)

| | | | Relative |
|---|---|---|---|
| | | | Shore-D |
| | Relative Shore-D | Relative Shore-D | Hardness |
| | Hardness after 1 Day | Hardness after 2 | after |
| Test Liquid | (% Δ) | Days (% Δ) | 7 Days (% Δ) |
| 20% H2SO4 | 0.00 | −2.44 | −6.10 |
| 20% NaOH | 0.00 | 0.00 | 0.00 |
| 5% Acetic | −18.29 | −26.83 | −46.34 |
| Acid | | | |
| 10% Acetic | −25.61 | −37.80 | −69.51 |
| Acid | | | |
| Gasoline | −3.66 | −3.66 | −20.73 |
| B.P.G. 5b | −14.63 | −18.29 | −26.83 |
| Xylene | −26.83 | −34.15 | −45.12 |
| MIBK | −20.73 | −28.05 | −42.68 |

TABLE 3
Inventive Example 2A (Hardener II with Polypox ® E 270)

| | | | Relative |
|---|---|---|---|
| | | | Shore-D |
| | Relative Shore-D | Relative Shore-D | Hardness |
| | Hardness after 1 Day | Hardness after 2 | after |
| Test Liquid | (% Δ) | Days (% Δ) | 7 Days (% Δ) |
| 20% H2SO4 | −24.39 | −26.83 | −26.83 |
| 20% NaOH | −17.07 | −17.07 | −17.07 |
| 5% Acetic | −26.83 | −32.93 | −48.78 |
| Acid | | | |
| 10% Acetic | −31.71 | −41.46 | −68.29 |
| Acid | | | |
| Gasoline | −17.07 | −17.07 | −17.07 |
| B.P.G. 5b | −26.83 | −29.27 | −34.15 |
| Xylene | −32.93 | −39.02 | −45.12 |
| MIBK | −26.83 | −32.93 | −43.90 |

TABLE 4
Comparative Example A (Polypox ® IH 7011 with Polypox ® E 270)

| | | | Relative |
|---|---|---|---|
| | | | Shore-D |
| | Relative Shore-D | Relative Shore-D | Hardness |
| | Hardness after 1 day | Hardness after 2 | after |
| Test Liquid | (% Δ) | Days (% Δ) | 7 Days (% Δ) |
| 20% H2SO4 | 2.56 | −2.56 | −3.84 |
| 20% NaOH | 0.00 | 0.00 | 0.00 |
| 5% Acetic | −21.79 | −26.92 | −39.74 |
| Acid | | | |
| 10% Acetic | −26.92 | −39.74 | −65.38 |
| Acid | | | |
| Gasoline | 0.00 | 0.00 | 0.00 |
| B.P.G. 5b | −10.26 | −15.38 | −23.07 |
| Xylene | −3.85 | −26.83 | −26.83 |
| MIBK | 0.00 | 0.00 | −34.00 |

TABLE 5
Inventive Example 1B (Hardener I with Polypox ® E 403)

| | | | Relative |
|---|---|---|---|
| | | | Shore-D |
| | Relative Shore-D | Relative Shore-D | Hardness |
| | Hardness after 1 Day | Hardness after 2 | after |
| Test Liquid | (% Δ) | Days (% Δ) | 7 Days (% Δ) |
| 20% H2SO4 | −1.25 | −1.25 | −1.25 |
| 20% NaOH | −2.50 | −2.50 | −2.50 |
| 5% Acetic | −6.25 | −6.25 | −6.25 |
| Acid | | | |
| 10% Acetic | −12.50 | −12.50 | −12.50 |
| Acid | | | |
| Gasoline | −15.00 | −15.00 | −27.50 |
| B.P.G. 5b | −13.75 | −13.75 | −26.25 |
| Xylene | −67.50 | −67.50 | −80.00 |
| MIBK | −51.25 | −51.25 | −83.75 |

TABLE 6
Inventive Example 2B (Hardener II with Polypox ® E 403)

| | | | Relative |
|---|---|---|---|
| | | | Shore-D |
| | Relative Shore-D | Relative Shore-D | Hardness |
| | Hardness after 1 Day | Hardness after 2 | after |
| Test Liquid | (% Δ) | Days (% Δ) | 7 Days (% Δ) |
| 20% H2SO4 | −2.50 | −3.75 | −3.75 |
| 20% NaOH | −2.50 | −1.25 | −2.50 |
| 5% Acetic | −2.50 | −3.75 | −10.00 |
| Acid | | | |
| 10% Acetic | −11.25 | −12.50 | −22.50 |
| Acid | | | |
| Gasoline | −8.75 | −12.50 | −25.00 |
| B.P.G. 5b | −11.25 | −13.75 | −27.50 |
| Xylene | −37.50 | −56.25 | −77.50 |
| MIBK | −26.25 | −43.75 | −82.50 |

TABLE 7
Comparative Example B (Polypox ® IH 7011 with Polypox ® E 403)

| | | | Relative |
|---|---|---|---|
| | | | Shore-D |
| | Relative Shore-D | Relative Shore-D | Hardness |
| | Hardness after 1 Day | Hardness after 2 | after |
| Test Liquid | (% Δ) | Days (% Δ) | 7 Days (% Δ) |
| 20% H2SO4 | 0.00 | 0.00 | 0.00 |
| 20% NaOH | 0.00 | 0.00 | 0.00 |
| 5% Acetic | −7.59 | −7.59 | −15.19 |
| Acid | | | |
| 10% Acetic | −13.92 | −16.46 | −34.18 |
| Acid | | | |
| Gasoline | −5.06 | −5.06 | −15.19 |
| B.P.G. 5b | −8.86 | −15.19 | −24.05 |
| Xylene | −24.05 | −32.91 | −63.29 |
| MIBK | −25.32 | −36.71 | −62.03 |

As is evident from the above Tables, the cured product exhibits an improved chemical stability against acetic acid particularly in comparison to Comparative Example B. Example 1A has an improved chemical stability against acetic acid after one day in comparison to Comparative Example A. Acetic acid is known to be one of the most destructive chemicals for amine-cured epoxies.

What is claimed is:

1. A hardener composition comprising:
a) a non-isolated adduct of
i) a monofunctional epoxy; and
ii) a first amine;
b) a second amine;
c) a modifier; and
d) an accelerator.

2. A hardener composition in accordance with claim 1 further comprising:
e) a third amine.

3. A hardener composition in accordance with claim 1 wherein said monofunctional epoxy is selected from the group consisting of cresyl glycidyl ether and t-butylphenyl glycidyl ether.

4. A hardener composition in accordance with claim 1 wherein said first amine is an aliphatic polyamine.

5. A hardener composition in accordance with claim 4 wherein said aliphatic polyamine is selected from the group consisting of isophoronediamine, TMDA and 1,3, BAC.

6. A hardener composition in accordance with claim 1 wherein said second amine is a polyether amine.

7. A hardener composition in accordance with claim 6 wherein said polyether amine is selected from the group consisting of poly(oxy(methyl-1,2-ethanediyl)), alpha-(2-aminomethylethyl)omega-(2-aminomethylethoxy), and mixtures thereof.

8. A hardener composition in accordance with claim 1 wherein said modifier is selected from the group consisting of styrenated phenol and diisopropylnaphthalene.

9. A hardener composition in accordance with claim 1 wherein said accelerator is selected from the group consisting of salicylic acid and calcium nitrate.

10. A hardener composition in accordance with claim 1 wherein the adduct is present in an amount in the range of from 10 weight percent to 80 weight percent, the second amine is present in an amount in the range of from 10 weight percent to 80 weight percent, the modifier is present in an amount in the range of from 5 weight percent to 50 weight percent, and the accelerator is present in an amount in the range of from 0.5 weight percent to 15 weight percent, based on the total weight of the composition.

11. A hardener composition in accordance with claim 2 wherein the third amine is present in an amount in the range of from 5 weight percent to 50 weight percent, based on the total weight of the composition.

12. A process comprising:
a) contacting a monofunctional epoxy and a first amine under reaction conditions to form an adduct wherein said reaction conditions do not include removing any unreacted first amine after said formation of said adduct; and
b) admixing
i) said adduct;
ii) a second amine;
iii) a modifier; and
iv) an accelerator
to form a hardener composition.

13. A process in accordance with claim 12 wherein said reaction conditions in step a) comprise a reaction temperature in the range of from 60° C. to 120° C.

14. A curable composition comprising:
I) the hardener composition of claim 1; and
II) an epoxy resin selected from the group consisting of liquid bisphenol-A diglycidyl ethers, liquid bisphenol-F diglycidyl ethers, liquid epoxy novolacs, solid bisphenol-A, and combinations thereof.

15. A primer prepared using the curable composition of claim 14.
